(19) United States
(12) Patent Application Publication
(10) Pub. No.: US 2007/0001913 A1
(43) Pub. Date: Jan. 4, 2007

(54) Multi-band planar antenna

(75) Inventors: Tiao-Hsing Tsai, Tao-Yuan Hsien (TW); Chien-Pin Chiu, Tao-Yuan Hsien (TW)

Correspondence Address: THE WEBB LAW FIRM, P.C., 700 KOPPERS BUILDING, 436 SEVENTH AVENUE, PITTSBURGH, PA, 15219, US

(73) Assignee: QUANTA COMPUTER INC., Tao-Yuan Hsien (TW)

(21) Appl. No.: 11/247,524

(22) Filed: Oct. 11, 2005

(30) Foreign Application Priority Data
Jul. 4, 2005 (TW) 094122535

(51) Int. Cl. H01Q 1/24

(52) U.S. Cl. 343/702; 343/700 MS

(57) ABSTRACT

A multi-band planar antenna includes first and second radiating elements. The first radiating element is operable within a first frequency bandwidth. The second radiating element is operable within a second frequency bandwidth. The first radiating element is formed with a slot that generates resonance within the second frequency bandwidth, thereby lowering the VSWR, widening the bandwidth, and increasing the antenna gain of the planar antenna in the second frequency bandwidth.

CROSS-REFERENCE TO RELATED APPLICATION

This application claims priority of Taiwanese application no. 094122535, filed on Jul. 4, 2005.

BACKGROUND OF THE INVENTION

1. Field of the Invention

This invention relates to a multi-band planar antenna, more particularly to a multi-band planar antenna applicable to a mobile phone.

2. Description of the Related Art

FIG. 1 illustrates a conventional multi-band planar antenna 1 disposed on a circuit board 100 of a mobile phone (not shown). The planar antenna 1 includes first and second radiating elements 11, 12, a feeding point 14, a grounding point 10, first and second meandering feeding strips 15, 18, and first and second meandering grounding strips 16, 19. The first radiating element 11 operates within the GSM 900 MHz bandwidth, is rectangular in shape, and has a pair of opposite first and second shorter sides 111, 112, and a pair of opposite third and fourth longer sides 113, 114. The first radiating element 11 is formed with a notch 130 at a corner thereof. The feeding point 14 is disposed adjacent to the first shorter side 111 of the first radiating element 11. The grounding point 10 is disposed adjacent to the third longer side 113 of the first radiating element 11. The first meandering feeding strip 15 has opposite ends connected respectively to the first shorter side 111 of the first radiating element 11 and the feeding point 14. The first meandering grounding strip 16 has opposite ends connected respectively to the second shorter side 112 of the first radiating element 11 and the grounding point 10. The second radiating element 12 operates within the DCS 1800 MHz and PCS 1900 MHz bandwidths, is rectangular in shape, and has a pair of opposite first and second shorter sides 121, 122, and a pair of opposite third and fourth longer sides 123, 124. The second radiating element 12 is disposed in the notch 130 in the first radiating element 11. The second meandering feeding strip 18 has opposite ends connected respectively to the first side 121 of the second radiating element 12 and the feeding point 14. The second meandering grounding strip 19 has opposite ends connected respectively to the third longer side 123 of the second radiating element 12 and the grounding point 10.

The aforementioned conventional planar antenna 1 is disadvantageous in that, based from experimental results, as illustrated in FIG. 3, the conventional planar antenna 1 provides a relatively high voltage standing wave ratio (VSWR), i.e., greater than three, within the DCS 1800 and PCS 1900 frequency bandwidths. Moreover, the conventional planar antenna 1 has an unsatisfactory bandwidth within the DCS 1800 and PCS 1900 frequency bandwidths, as indicated by line 20. Further, as illustrated in FIG. 4, the conventional planar antenna 1 has a relatively low antenna gain within the DCS 1800 and PCS 1900 frequency bandwidths, as indicated by the diamond symbols.

### SUMMARY OF THE INVENTION

Therefore, the object of the present invention is to provide a multi-band planar antenna that can overcome the aforesaid drawbacks of the prior art.

According to the present invention, a multi-band planar antenna comprises first and second radiating elements. The first radiating element is operable within a first frequency bandwidth. The second radiating element is operable within a second frequency bandwidth. The first radiating element is formed with a slot that generates resonance within the second frequency bandwidth.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional multi-band planar antenna mounted on a circuit board;

FIG. 2 is a schematic view of the preferred embodiment of a multi-band planar antenna according to the present invention;

FIG. 3 is a plot to illustrate voltage standing wave ratios and bandwidths of the conventional planar antenna and the preferred embodiment; and

FIG. 4 is a plot to illustrate antenna gains of the conventional planar antenna and the preferred embodiment.

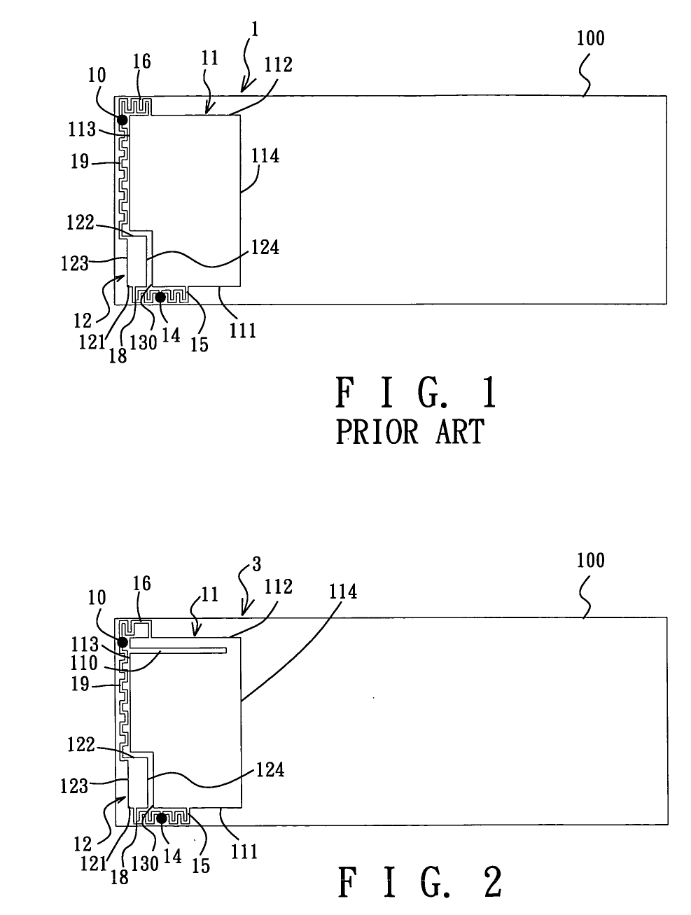

### DETAILED DESCRIPTION OF THE PREFERRED EMBODIMENT

Referring to FIG. 2, the preferred embodiment of a multi-band planar antenna 3 according to this invention is shown to include first and second radiating elements 11, 12, a feeding point 14, a grounding point 10, first and second feeding strips 15, 18, and first and second grounding strips 16, 19.

The multi-band planar antenna 3 of this embodiment is to be disposed on a circuit board 100 of a mobile phone (not shown).

The first radiating element 11 is operable within a first frequency bandwidth, i.e., within the GSM 900 MHz. In this embodiment, the first radiating element 11 is generally rectangular in shape, and has a pair of first and second sides 111, 112 opposite to each other in a first direction, and a pair of third and fourth sides 113, 114 opposite to each in a second direction transverse to the first direction. It is noted that the first and second sides 111, 112 of the first radiating element 11 are shorter than the third and fourth sides 113, 114 of the first radiating element 11. The first radiating element 11 is formed with a notch 130 at a corner thereof such that the first side 111 of the first radiating element 11 is shorter than the second side 112 of the first radiating element 11, and such that the third side 113 of the first radiating element 11 is shorter than the fourth side 114 of the first radiating element 11.

The feeding point 14 is disposed closer to the notch 130 in the first radiating element 11 than the grounding point 10. In particular, the feeding point 14 is disposed adjacent to the first side 111 of the first radiating element 11 near the notch 130 in the first radiating element 11. The grounding point 10 is disposed adjacent to the third side 113 of the first radiating element 11 near a junction of the second and third sides 112, 113 of the first radiating element 11.

The first feeding strip 15 has opposite ends connected respectively to the first side 111 of the first radiating element 11 and the feeding point 14.

The first grounding strip 16 has opposite ends connected respectively to the second side 112 of the first radiating element 11 and the grounding point 10.

In this embodiment, the first feeding strip 15 and the first grounding strip 16 are configured with a meandering shape.

The second radiating element 12 is operable within a second frequency bandwidth, i.e., within the DCS 1800 MHz and the PCS 1900 MHz bandwidths. In this embodiment, the second radiating element 12 is generally rectangular in shape, and has a pair of first and second sides 121, 122 opposite to each other in the first direction, and a pair of third and fourth sides 123, 124 opposite to each other in the second direction. It is noted that the first and second sides 121, 122 of the second radiating element 12 are shorter than the third and fourth sides 123, 124 of the second radiating element 12. The second radiating element 12 has a size that is slightly smaller than the notch 130 in the first radiating element 11, and is disposed in the notch 130.

The second feeding strip 18 has opposite ends connected respectively to the first side 121 of the second radiating element 12 and the feeding point 14.

The second grounding strip 19 has opposite ends connected respectively to the third side 123 of the second radiating element 12 and the grounding point 10.

In this embodiment, the second feeding strip 18 and the second grounding strip 19, like the first feeding strip 15 and the first grounding strip 16, are configured with a meandering shape.

The first radiating element 11 is formed with a slot 110 that extends from the third side 113 toward the fourth side 114 of the first radiating element 11. The slot 110 in the first radiating element 11 is dimensioned so as to generate resonance within the second frequency bandwidth.

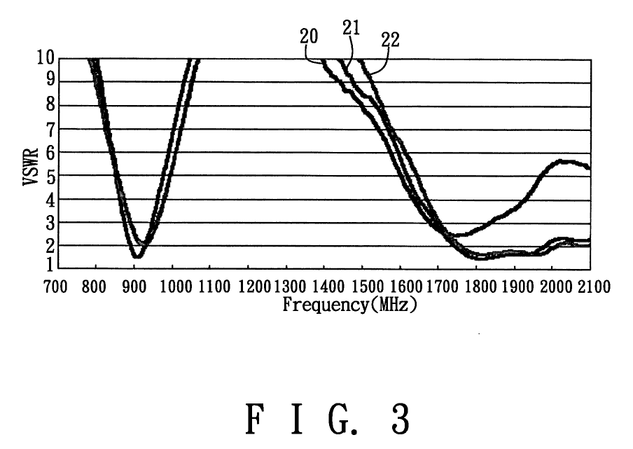

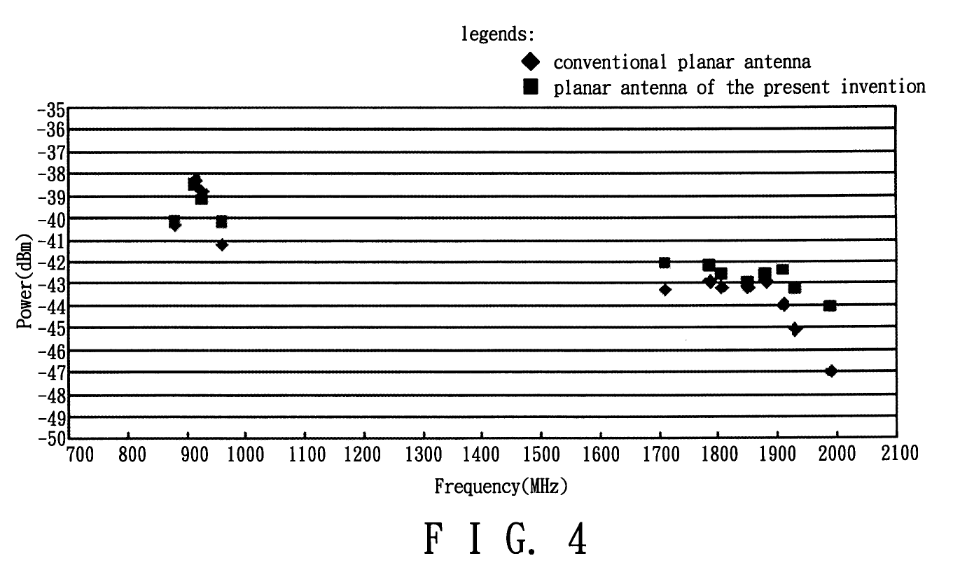

Based from experimental results, as illustrated in FIG. 3, when the length dimension of the slot 110 in the first radiating element 11 is chosen to be 18.5 and 16 millimeters, the planar antenna 3 of this invention provides voltage standing wave ratios (as indicated by lines 21 and 22) of less than two within the second frequency bandwidth. Moreover, the bandwidth of the planar antenna 3 of this invention within the second frequency bandwidth is considerably widened, notably within the PCS 1900 MHz bandwidth. Further, the antenna gain of the planar antenna 3 of this invention within the second frequency bandwidth, as illustrated in FIG. 4, is dramatically increased. Indeed, the slot 110 in the first radiating element 11 lowers the VSWR, widens the bandwidth, and increases the antenna gain within the second frequency bandwidth.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A multi-band planar antenna, comprising:
a first radiating element operable within a first frequency bandwidth; and
a second radiating element operable within a second frequency bandwidth;
wherein said first radiating element is formed with a slot that generates resonance within the second frequency bandwidth.

2. The multi-band planar antenna as claimed in claim 1, wherein said first radiating element has first and second sides opposite to each other in a first direction, and third and fourth sides opposite to each other in a second direction transverse to the first direction, said multi-band planar antenna further comprising:
a feeding point disposed adjacent to said first side of said first radiating element;
a first feeding strip having opposite ends connected respectively to said first side of said first radiating element and said feeding point;
a grounding point disposed adjacent to said third side of said first radiating element; and
a first grounding strip having opposite ends connected respectively to said second side of said first radiating element and said grounding point.

3. The multi-band planar antenna as claimed in claim 2, wherein said second radiating element has first and second sides opposite to each other in the first direction, and third and fourth sides opposite to each other in the second direction, said multi-band planar antenna further comprising:
a second feeding strip having opposite ends connected respectively to said first side of said second radiating element and said feeding point; and
a second grounding strip having opposite ends connected respectively to said third side of said second radiating element and said grounding point.

4. The multi-band planar antenna as claimed in claim 3, wherein said first radiating element is generally rectangular in shape, said first and second sides of said first radiating element being shorter than said third and fourth sides of said first radiating element, said first radiating element being formed with a notch at a corner thereof such that said first side of said first radiating element is shorter than said second side of said first radiating element and such that said third side of said first radiating element is shorter than said fourth side of said first radiating element, said feeding point being disposed closer to said notch in said first radiating element than said grounding point, said second radiating element being disposed in said notch in said first radiating element.

5. The multi-band antenna as claimed in claim 4, wherein said slot extends from said third side toward said fourth side of said first radiating element.

6. The multi-band antenna as claimed in claim 1, wherein the first frequency bandwidth is lower than the second frequency bandwidth.

7. The multi-band antenna as claimed in claim 6, wherein the first frequency bandwidth is GSM 900 MHZ, and the second frequency bandwidth is DCS 1800/PCS 1900 MHz.
